(19) United States
(12) Patent Application Publication
(10) Pub. No.: US 2016/0153863 A1
(43) Pub. Date: Jun. 2, 2016

(54) VIBRATING SIMULATION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN-WEN KOU, Shenzhen (CN); XIANG-WU LONG, Shenzhen (CN)

(21) Appl. No.: 14/590,202

(22) Filed: Jan. 6, 2015

(30) Foreign Application Priority Data
Nov. 27, 2014 (CN) 201410695094.9

(51) Int. Cl. G01M 7/02

(52) U.S. Cl. CPC G01M 7/027; G01M 7/022

(57) ABSTRACT

A vibrating simulation device is configured to test an object. The vibrating simulation device includes a carrying module, a driving module and a pressing module. The carrying module carries the object. The driving module drives the carrying module to vibrate. The press module is located upon the carrying module and presses on the object. The pressing module includes a bag and fillers. The fillers are replaceably filled in the bag.

### CROSS-REFERENCE TO RELATED APPLICATIONS

This application claims priority to Chinese Patent Application No. 201410695094.9 filed on Nov. 27, 2014, the contents of which are incorporated by reference herein.

### FIELD

The subject matter herein generally relates to a vibrating simulation device, and particularly to a vibrating simulation device used for simulating an object being in a continuous jolty process and a long time accumulated process.

### BACKGROUND

An object is in a continuous jolty process and a long time accumulated process during transport, and the jolty process and the accumulated process may damage the object. However, before transport, it is difficult for a designer to discover quick-wear parts of the object.

### BRIEF DESCRIPTION OF THE DRAWINGS

Implementations of the present technology will now be described, by way of example only, with reference to the attached figures.

FIG. 1 is a cross sectional view of a vibrating simulation device in accordance with an exemplary embodiment.

FIG. 2 is a partial cross sectional, isometric view of a pressing module of the vibrating simulation device of FIG. 1.

FIG. 3 is an isometric view of the pressing module of the vibrating simulation device of FIG. 1.

### DETAILED DESCRIPTION

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

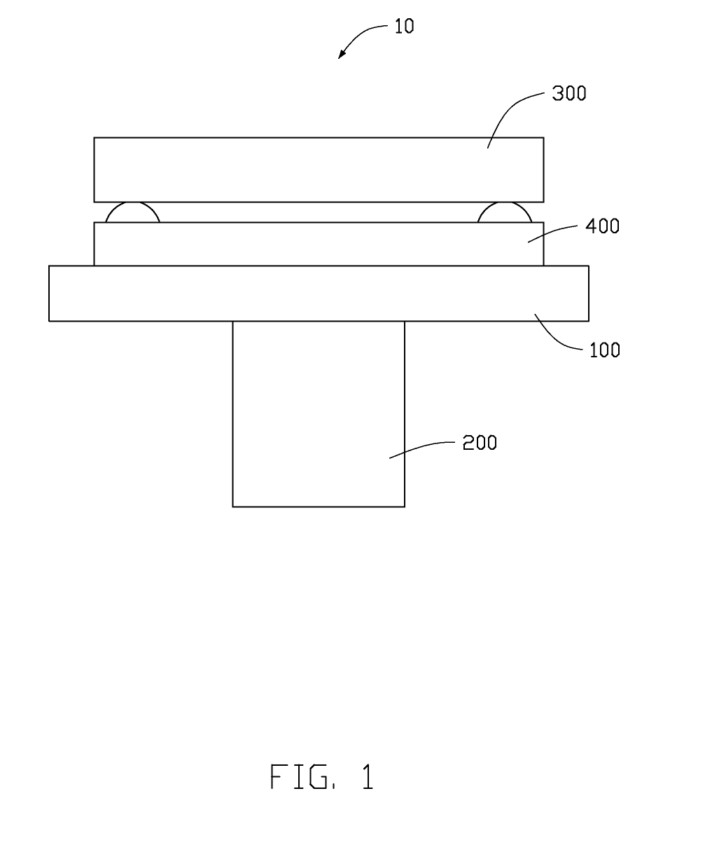

Referring to FIG. 1, a vibrating simulation device 10 comprises a carrying module 100, a driving module 200 and a pressing module 300. The vibrating simulation device 10 is configured to test an object 400.

The carrying module 100 carries the object 400. The object 400 is positioned on the carrying module 100. The driving module 200 drives the carrying module 100 to vibrate. The driving module 200 can comprise a transmission (not shown) and a timer (not shown). The pressing module 300 is located upon the carry module 100 for pressing on the object 100.

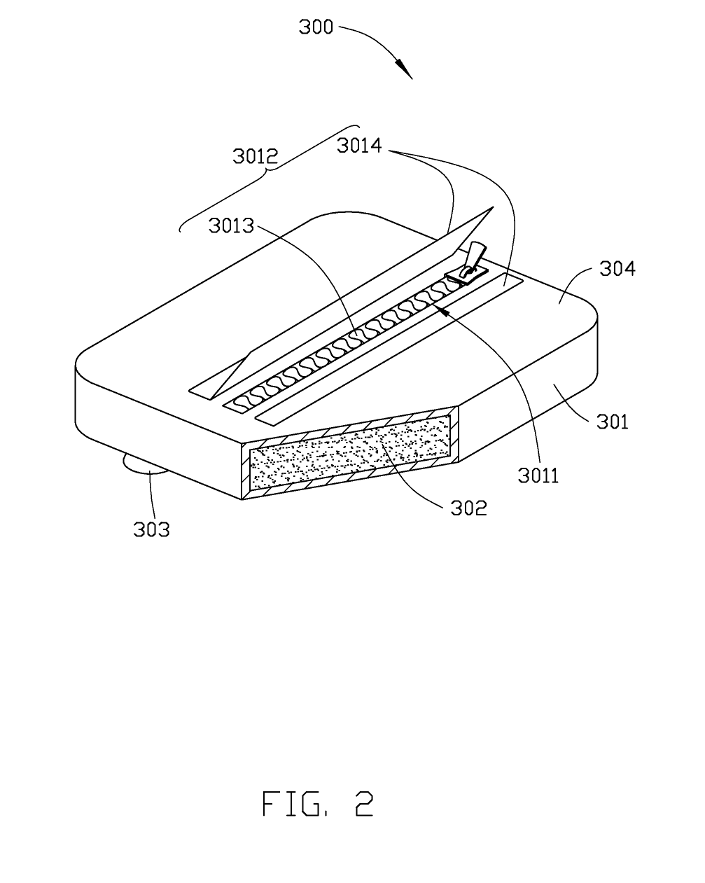

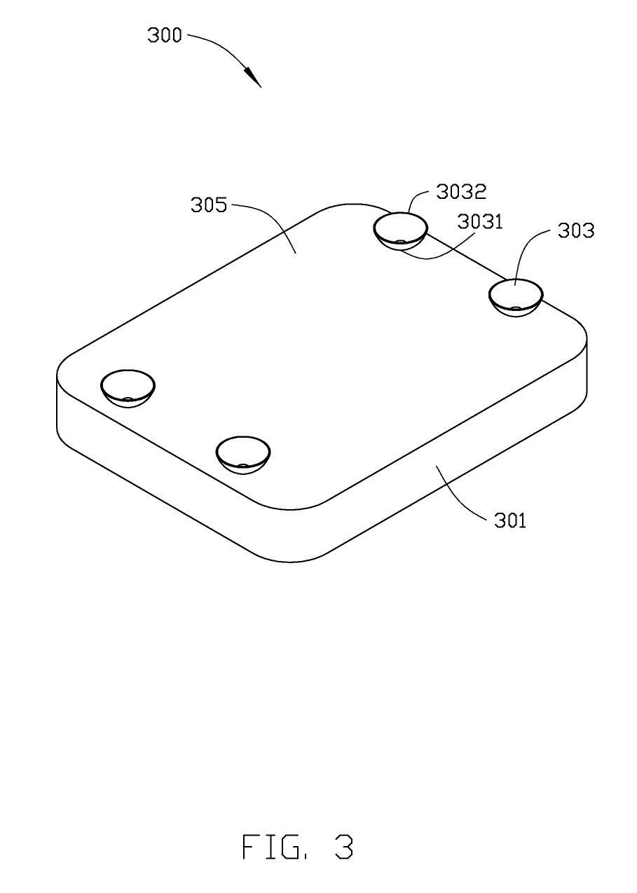

Referring to FIGS. 2-3, the pressing module 300 comprises a bag 301 and fillers 302. The fillers 302 are replaceably filled in the bag 301.

A size and a shape of the bag 301 can be changed. The bag 301 can be a rectangular bag. In at least one embodiment, a size of the bag 301 can be 300 mm×200 mm×25 mm. In another embodiment, the size of the bag 301 can be 100 mm×100 mm×100 mm. The bag 301 can be a cylindrical bag. A radius of the bag 301 can be 100 mm. A height of the bag 301 can be 100 mm. The bag 301 can be made of cloth or leather.

The bag 301 comprises an opening 3011 and a switch 3012. The bag 301 defines a top surface 304 and a bottom surface 305 opposite to the top surface 304. The bottom surface 305 faces the object 400. The top surface 304 is away from the object 400. The opening 3011 is defined on the bag 301. The opening 3011 can be defined on the top surface 304 of the bag 301. The fillers 302 can be filled in the bag 301 through the opening 3011. The switch 3012 can be arranged on the bag 301. The switch 3012 is coupled to the opening 3011 for opening or closing the opening 3011. The switch 3012 can comprise a zipper 3013. The zipper 3013 is arranged at the opening 3011 to envelop the opening 3011. The switch 3012 can also comprise a connecting portion 3014. The connecting portion 3014 is arranged on the bag 301. The connecting portion 3014 can be arranged on the top surface 304 of the bag 301. The connecting portion 3014 covers the zipper 3013. The connecting portion 3014 can be an adhesive cloth or magnetic portion.

The fillers 302 can be powders. In at least one embodiment, the fillers 302 can be lead powders. It can be understood that the fillers 302 can be particles or cakes. A weight of the fillers 302 can be 5-20 kilograms. In at least one embodiment, the weight of fillers 302 can be 10 kilograms.

The vibrating simulation device 10 can comprise a plurality of suction cups 303. Each suction cup 303 comprises a fixed end 3031 and a connecting end 3032. The fixed end 3031 is fixed to the bag 301. In at least one embodiment, the fixed end 3031 is fixed on an outside of the bottom surface 305 of the bag 301. The connecting end 3032 can be attached onto the object 400. When the connecting end 3032 is attached to the object 400, air in the suction cup 303 can be exhausted from the connecting end 3032 by being extruded by the suction cup 303; when the connecting end 3032 is discharged from the object 400, air is inflated into the suction cup 303 from the connecting end 3032. The suction cup 303 can be made of leather, rubber or plastic. The number of the suction cup 303 can be four. When the object 400 is in a continuous jolty process and a long time accumulated process, the suction cups 303 can prevent the bag 301 with fillers 302 from falling down from the top surface 304 of the object 400.

The embodiments shown and described above are only examples. Many details are often found in the art such as the other features of a vibrating simulation device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A vibrating simulation device configured to test an object comprising:
a carrying module configured to carry the object;
a driving module configured to drive the carrying module to vibrate; and
a pressing module located upon the carrying module and configured for pressing the object, the pressing module comprising a bag and fillers replaceably filled in the bag.

2. The vibrating simulation device of claim 1, wherein the bag comprises an opening and a switch, the opening is defined on the bag, and the switch is coupled to the opening for opening or closing the opening.

3. The vibrating simulation device of claim 2, wherein the switch comprises a zipper, and the zipper is arranged at the opening to envelop the opening.

4. The vibrating simulation device of claim 3, wherein the switch comprises a connecting portion, and the connecting portion is arranged on the bag and covers the zipper.

5. The vibrating simulation device of claim 4, wherein the connecting portion is an adhesive cloth or a magnetic portion.

6. The vibrating simulation device of claim 1, wherein the bag is made of cloth or leather.

7. The vibrating simulation device of claim 1, wherein the fillers are powders.

8. The vibrating simulation device of claim 1, wherein a weight of the fillers is 5-20 kilograms.

9. The vibrating simulation device of claim 1 further comprising a plurality of suction cups, each suction cup comprises a fixed end and a connecting end, the fixed end is fixed to the bag, and the connecting end is attached onto the object.

10. The vibrating simulation device of claim 2, wherein the suction cup is made of leather, rubber or plastic.
